(19) United States
(12) Patent Application Publication
(10) Pub. No.: US 2024/0212263 A1
(43) Pub. Date: Jun. 27, 2024

(54) METHOD OF SELECTING 2D INPUT IMAGE, IMAGE PROCESSING APPARATUS, AND IMAGE RECONSTRUCTION APPARATUS FOR 3D RECONSTRUCTION

(71) Applicant: ELECTRONICS AND TELECOMMUNICATIONS RESEARCH INSTITUTE, Daejeon (KR)

(72) Inventors: Man Hee LEE, Daejeon (KR); Chang Joon PARK, Daejeon (KR)

(73) Assignee: ELECTRONICS AND TELECOMMUNICATIONS RESEARCH INSTITUTE, Daejeon (KR)

(21) Appl. No.: 18/340,575

(22) Filed: Jun. 23, 2023

(30) Foreign Application Priority Data
Dec. 23, 2022 (KR) 10-2022-0182630

(51) Int. Cl. G06T 15/20; G06T 7/60; G06V 10/44; G06V 10/74

(52) U.S. Cl. CPC G06T 15/205; G06T 7/60; G06V 10/44; G06V 10/761

(57) ABSTRACT

Provided is a method of selecting a two dimension (2D) image for three dimension (3D) reconstruction, the method including: receiving, by an image processing apparatus, 2D images captured at different positions or in different directions; estimating, by the image processing apparatus, a geometric structure of a camera based on feature points detected from the 2D images, and optimizing the geometric structure of the camera using a bundle adjustment (BA) technique; determining, by the image processing apparatus, a priority for each of the 2D images based on a number of tie points used in the BA process; and selecting, by the image processing apparatus, final 2D images to be used for 3D reconstruction based on the priorities of the 2D images.

### CROSS-REFERENCE TO RELATED APPLICATION

This application claims the benefit under 35 U.S.C. § 119(a) of Korean Patent Application No. 10-2022-0182630, filed on Dec. 23, 2022, in the Korean Intellectual Property Office, the entire disclosure of which is incorporated herein by reference for all purposes.

### BACKGROUND

### 1. Field

The following description relates to a technique of selecting a two dimension (2D) image for three dimension (3D) image reconstruction.

### 2. Discussion of Related Art

A method of reconstructing a three dimension (3D) structure of an object using two dimension (2D) images has been studied. Representative techniques for 3D reconstruction include a multi-view stereo (MVS), a deep learning-based neural radiance field (NeRF), and the like. The quality of a 3D reconstruction result is basically determined by input images. The quality of a 3D reconstruction result is improved when many input images are used, but the reconstruction time increases as the number of input images increases.

### SUMMARY

In one general aspect, there is provided a method of selecting a two dimension (2D) image for three dimension (3D) reconstruction, including: receiving, by an image processing apparatus, 2D images captured at different positions or in different directions, estimating, by the image processing apparatus, a geometric structure of a camera based on feature points detected from the 2D images, and optimizing the geometric structure of the camera using a bundle adjustment (BA) technique, determining, by the image processing apparatus, a priority for each of the 2D images based on a number of tie points used in the BA process and selecting, by the image processing apparatus, final 2D images to be used for 3D reconstruction based on the priorities of the 2D images.

In another aspect, there is provided an image reconstruction apparatus for reconstructing a three dimension (3D) image, including: an interface device configured to receive 2D images captured at different positions or in different directions and an arithmetic device configured to estimate a geometric structure of a camera based on feature points detected from the 2D images, optimize the geometric structure of the camera using a bundle adjustment (BA) technique, determine a priority for each of the 2D images based on a number of tie points used in the BA process, select effective 2D images among the 2D images based on the priorities and reconstruct a 3D image using the effective 2D images.

### BRIEF DESCRIPTION OF THE DRAWINGS

FIG. 1 illustrates an example of a system for reconstructing a 3D image based on a priority.

FIG. 2 illustrates an example of a process of determining priorities of 2D images in an image set.

FIG. 3 illustrates an example of an image processing apparatus that determines priorities of 2D images.

FIG. 4 illustrates an example of an image reconstruction apparatus that reconstructs a 3D image using a 2D image set.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION OF EXEMPLARY EMBODIMENTS

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

As used herein, the term “and/or” includes any one and any combination of any two or more of the associated listed items.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

The technology described below is a technique of selecting 2D images for 3D reconstruction. The technology described below is a technique of selecting effective 2D images from a set of collected 2D images. The technology to be described below is a technique of determining priorities of images included in a 2D image set.

The technology described below is not limited to a specific 3D reconstruction technique. The technology described below may be applied to various technique of performing 3D reconstruction using 2D images.

The 3D reconstruction is performed by a certain image processing apparatus. Accordingly, the image processing apparatus may determine the priorities of 2D images included in a collected 2D image set. Meanwhile, the prioritization of 2D images may be performed in an image collection process. An image collecting apparatus may assign priorities to 2D images acquired by a plurality of cameras in advance. Effective 2D images may be selected from a 2D image set based on the priorities determined by the image collecting apparatus.

As described above, an apparatus for assigning priorities to 2D images and an apparatus for performing 3D reconstruction may be separate apparatuses. However, for the sake of convenience of description, it will be described that an image processing apparatus determines the priorities of 2D images to be used for 3D reconstruction. The image processing apparatus may determine the priorities based on image features of collected 2D images.

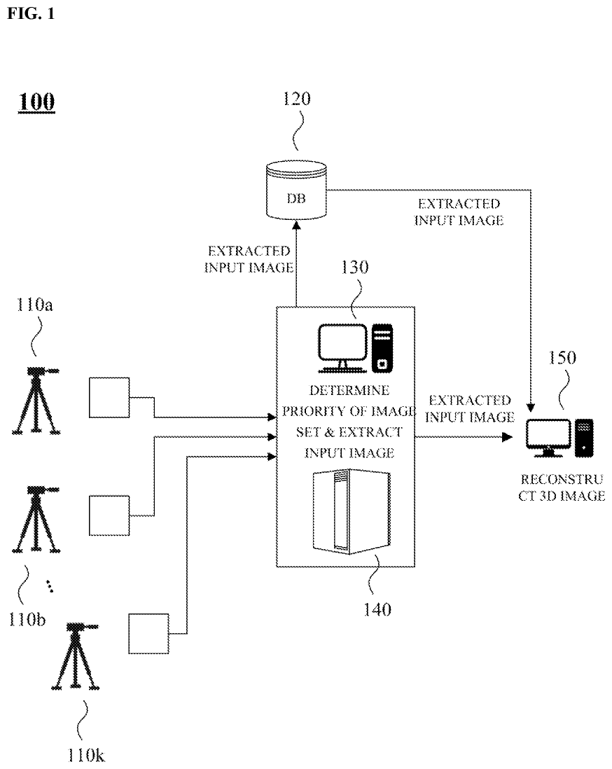

FIG. 1 is an example of a system 100 for reconstructing a 3D image based on a priority. In FIG. 1, an example in which an image processing apparatus is a computer terminal 130 or a server 140 is illustrated.

Cameras 110a, 110b, . . . , and 110k capture 2D images of a specific object or region. The cameras 110a, 110b, . . . , and 110k may be adjacent to each other and capture images of the same object. The cameras 110a, 110b, . . . , and 110k are at different positions and have different orientations. In some cases, a single camera may generate a plurality of images while moving.

The computer terminal 130 receives an image set including the plurality of 2D images generated by the cameras 110a, 110b, . . . , and 110k as an input. The computer terminal 130 determines priorities of the images included in the image set to extract input images to be used for 3D reconstruction. A process of determining priorities of images will be described below. The computer terminal 130 may store the extracted input images in a database (DB) 120.

The server 140 receives an image set including the plurality of 2D images generated by the cameras 110a, 110b, . . . , and 110k. The server 140 determines priorities of the images included in the image set to extract input images to be used for 3D reconstruction. A process of determining priorities of images will be described below. The server 140 may store the extracted input images in the database (DB) 120.

An image reconstruction apparatus 150 receives the extracted input images from the DB 120, the computer terminal 130, or the server 140. The image reconstruction apparatus 150 may be a separate apparatus for 3D reconstruction. In some cases, the image reconstruction apparatus 150 may be the same object as the computer terminal 130 or the server 140. The image reconstruction apparatus 150 may generate a 3D reconstruction image using the extracted 2D input images.

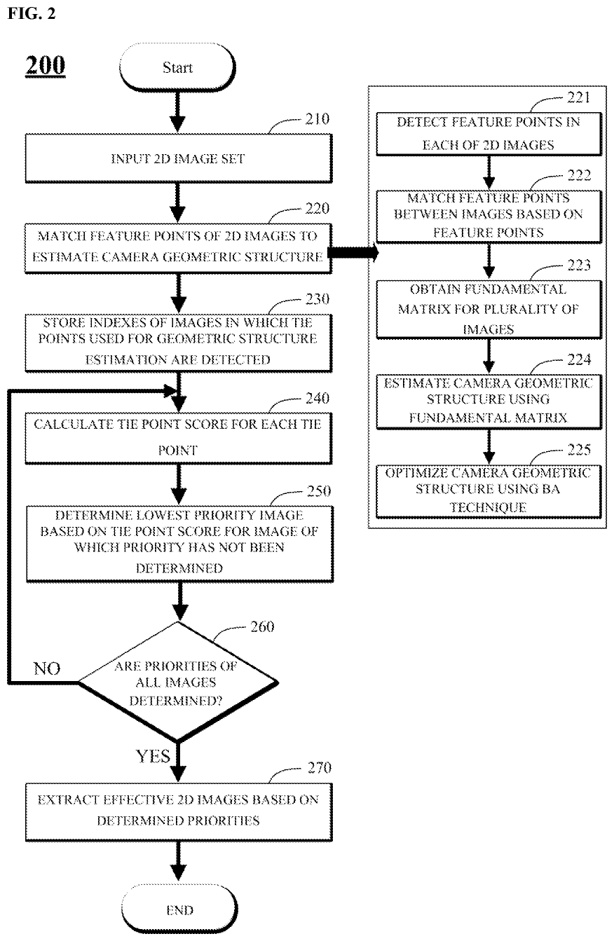

FIG. 2 is an example of a process 200 of determining the priorities of 2D images in an image set.

The image processing apparatus receives a 2D image set [symbol] as an input (210). The 2D image set [symbol] includes N 2D images as shown in Equation 1 below. The N 2D images may be composed of images captured at different locations or viewpoints in the real world.

$$𝒥 = {\{ {I}_{i} \}}_{i = 1}^{N} \qquad [ Equation 1 ]$$

In Equation 1, Iᵢ denotes an i^{th} 2D image.

The image processing apparatus detects feature points from the 2D images and matching the feature points to estimate a camera geometric structure (220).

The image processing apparatus detects a feature point in each of the 2D images using an image feature extraction technology (221). The image processing apparatus may use any one of various image feature extraction techniques. The image feature extraction techniques may include scale invariant feature transform (SIFT) and speeded up robust features (SURF), oriented fast and rotated BRIEF (ORB), and the like. The image processing apparatus may extract feature points of images using SIFT, which is robust against image rotation, size changes, and brightness changes and has a high feature detection recall. Feature point information is also referred to as a descriptor.

The image processing apparatus extracts feature points for each of images I₁ to Iₙ.

The image processing apparatus matches feature points between images based on feature points for the images I₁ to Iₙ (222). The image processing apparatus may determine images having corresponding features by matching feature points. Images having corresponding features may be regarded as having the same object overlapping therein. In addition, the image processing apparatus may match feature points between a plurality of images to confirm points corresponding to each other (correspondence points).

The image processing apparatus obtains a fundamental matrix for a plurality of images (223). The fundamental matrix includes a relationship between a point of an image captured by one camera and a point of an image captured by another camera on an image coordinate system. In order to obtain a fundamental matrix, correspondence points of a plurality of images are needed. Here, the correspondence points represent matched feature points. Algorithms for obtaining a fundamental matrix using correspondence points include a linear technique (the 8 point algorithm, etc.) or a non-linear technique (RANdom SAmple Consensus: RANSAC) and the like.

The image processing apparatus may estimate a geometric structure (a position and an orientation) of a camera using the fundamental matrix (224). For example, the image processing apparatus may estimate a geometric structure of a camera using a Perspective 3-Point (P3P) algorithm. The P3P algorithm is an algorithm for estimating the position of a camera based on the positions of three points of which coordinates are known in the real world coordinate system and three points projected on an image plane.

Furthermore, the image processing apparatus may optimize the geometric structure of the camera using a technique, such as bundle adjustment (BA) and the like (225). BA is a process for minimizing a reprojection error according to an estimated camera geometric structure. BA uses camera positions and specific points. The points used by the image processing apparatus in BA are referred to as tie points. A tie point set [symbol] that is, all M sets of tie points used in BA are expressed as in Equation 2 below.

$$𝒥 = {\{ {T}_{j} \}}_{j = 1}^{M} \qquad [ Equation 2 ]$$

In Equation 2, Tⱼ denotes a j^{th} tie point.

The image processing apparatus stores indexes of images in which tie points used for geometric structure estimation are detected (230). In addition, a tie point set [symbol] (i) , that is, m sets of tie points present in an image Iᵢ are expressed as in Equation 3 below.

$$𝒥 ( i ) = {\{ {T}_{k} \vert {T}_{k} ∈ {I}_{i} \}}_{k = 1}^{m} \qquad [ Equation 3 ]$$

For a tie point Tⱼ, an index set Ind (Tⱼ) of n images from which the tie point Tⱼ is detected may be expressed as Equation 4 below.

$$Ind ( {T}_{j} ) = {\{ {i}_{k} \vert {T}_{j} ∈ 𝒥 ( i ) \}}_{k = 1}^{n} \qquad [ Equation 4 ]$$

The image processing apparatus calculates a score for the tie point Tⱼ (240). The score for the tie point Tⱼ is |Ind(Tⱼ)|=n. That is, the score for a tie point corresponds to the number of images having the corresponding tie point. The image processing apparatus calculates scores for all tie points used in BA (240).

The image processing apparatus sums the scores of tie points present in each image and calculates an average. The image processing apparatus may determine a priority of a lowest priority image based on the tie point score for an image of which a priority has not been determined and belonging to the 2D image set (250). For example, an image Iₗ having the highest average score in the 2D image set [symbol] is assigned the lowest priority in the 2D image set [symbol] . That is, among 2D images, an image with a larger number of common tie points (i.e., a large number of features) is assigned a lower priority.

The image processing apparatus repeats the above process until priorities of all images in the 2D image set [symbol] are determined (260). For example, the image processing apparatus determines the lowest priority among n 2D images, and then excludes a 2D image assigned the lowest priority and determines the lowest priority among n-1 2D images. The image processing apparatus repeats the process of determining the lowest priority until priorities are determined for all 2D images.

The image processing apparatus may exclude a certain number of images having lower priorities from the 2D image set [symbol] based on the priorities in the 2D image set. Alternatively, the image processing apparatus may exclude only an image having the lowest priority in the 2D image set [symbol] from the 2D image set [symbol] . Alternatively, the image processing apparatus may select only a certain number of 2D images having higher priorities from the 2D image set [symbol] and leave the selected 2D images in the 2D image set [symbol] (270).

The image processing apparatus may finally perform 3D reconstruction using the 2D images remaining in the 2D image set [symbol] . The 2D images remaining in the 2D image set [symbol] in the end are referred to as effective 2D images.

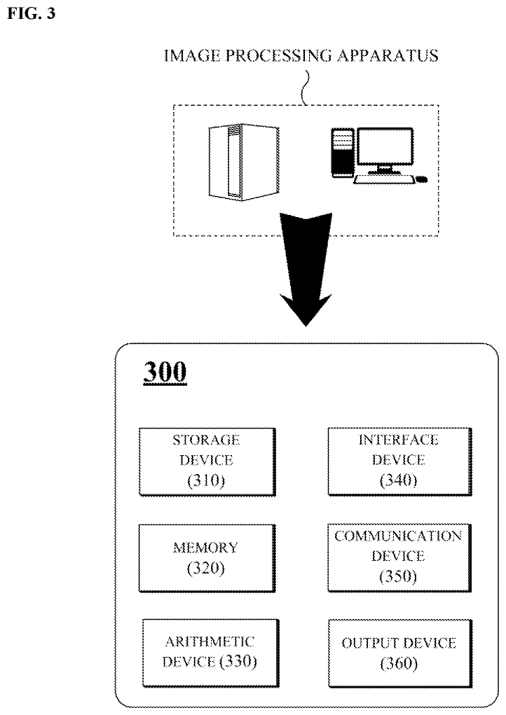

FIG. 3 is an example of an image processing apparatus 300 that determines priorities of 2D images.

The image processing apparatus 300 corresponds to the image processing apparatus (130 and 140 shown in FIG. 1) described above. The image processing apparatus 300 may be physically implemented in various forms. For example, the image processing apparatus 300 may have a form of a computer device, such as a personal computer (PC), a server of a network, a data processing dedicated chipset, and the like.

The image processing apparatus 300 may include a storage device 310, a memory 320, an arithmetic device 330, an interface device 340, a communication device 350, and an output device 360.

The storage device 310 may store an initial 2D image set. The initial 2D image set includes all 2D images that may be used for 3D reconstruction.

The storage device 310 may store a program or code for determining the priorities in the 2D image set as described above.

The storage device 310 may store 2D images (effective 2D images) finally selected according to the priorities.

The memory 320 may store data and information generated in the process of determining the priorities of the image processing apparatus 300.

The interface device 340 is a device that receives certain commands and data from the outside. The interface device 340 may receive the initial 2D image set from an input device physically connected thereto or an external storage device. The interface device 340 may also transmit effective 2D images to an external object.

The communication device 350 refers to a component that receives and transmits certain information through a wired or wireless network. The communication device 350 may receive the initial 2D image set from an external object. Alternatively, the communication device 350 may transmit effective 2D images to an external object, such as a separate image reconstruction apparatus.

The interface device 340 may be a component that receives data via the communication device 350.

The output device 360 is a device that outputs certain information. The output device 360 may output an interface required for data processing, an effective 2D image list, a reconstructed 3D image, and the like.

The arithmetic device 330 detects feature points for each of the 2D images belonging to the initial 2D image set. The arithmetic device 330 matches feature points between images based on feature points of 2D images. Matched feature points represent correspondence points. The arithmetic device 330 obtains a fundamental matrix for 2D images using the correspondence points between images. The process of obtaining the fundamental matrix is the same as described above. The arithmetic device 330 may estimate a camera geometric structure using the fundamental matrix. The arithmetic device 330 may optimize the camera geometric structure using the BA technique. The arithmetic device 330 extracts the tie point(s) used in the BA technique.

The arithmetic device 330 determines an index set of images in which tie points used for geometric structure estimation are detected.

The arithmetic device 330 determines priorities based on each tie point to configure effective 2D images. The arithmetic device 330 calculates a tie point score for each point. The arithmetic device 330 determines the priority based on an average value of tie point scores for each image. The arithmetic device 330 may remove a 2D image having the lowest priority or a plurality of lower priority 2D images from the 2D image set based on the priority. Through this process, the arithmetic device 330 may extract effective 2D images.

Furthermore, the arithmetic device 330 may perform 3D image reconstruction using the effective 2D images.

The arithmetic device 330 may be a device, such as a processor, an application processor (AP), or a chip in which a program is embedded, for processing data and performing certain arithmetic operations.

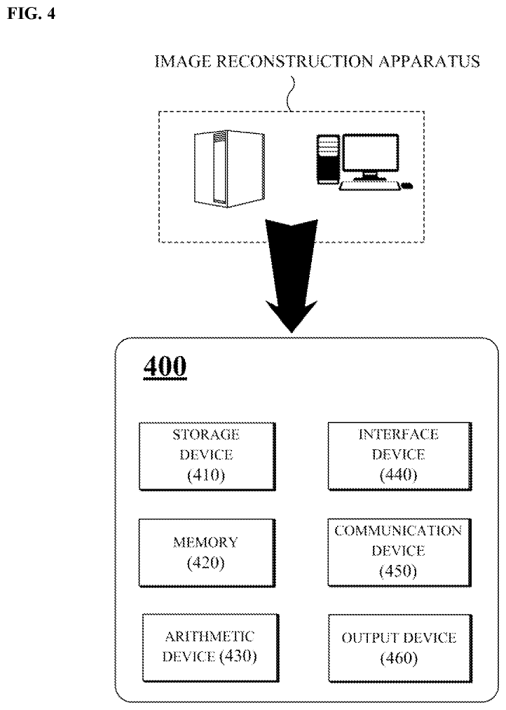

FIG. 4 is an example of an image reconstruction apparatus 400 that reconstructs a 3D image using a 2D image set. The image reconstruction apparatus 400 reconstructs a 3D image using a set of selected 2D images.

The image reconstruction apparatus 400 may be physically implemented in various forms. For example, the image reconstruction apparatus 400 may have a form of a computer device, such as a PC, a network server, and a data processing dedicated chipset, or the like.

The image reconstruction apparatus 400 may include a storage device 410, a memory 420, an arithmetic device 430, an interface device 440, a communication device 450, and an output device 460.

The storage device 410 may store an initial 2D image set. The initial 2D image set includes all 2D images that may be used for 3D reconstruction.

The storage device 410 may store a program or code for determining the priorities in the 2D image set as described above.

The storage device 410 may store 2D images (effective 2D images) finally selected according to the priorities.

The storage device 410 may store a program or code for reconstructing a 3D image using the 2D image set.

The memory 420 may store data and information generated in the process of reconstructing the 3D image of the image reconstruction apparatus 400.

The interface device 440 is a device that receives certain commands and data from the outside. The interface device 440 may receive the initial 2D image set from an input device physically connected thereto or an external storage device. The interface device 440 may also transmit the reconstructed 3D image to an external object.

The communication device 450 refers to a component that receives and transmits certain information through a wired or wireless network. The communication device 450 may receive the initial 2D image set from an external object. Alternatively, the communication device 450 may transmit the reconstructed 3D image to an external object.

The interface device 440 may be a component that receives data via the communication device 450.

The output device 460 is a device that outputs certain information. The output device 460 may output an interface required for data processing, an effective 2D image list, a reconstructed 3D image, and the like.

The arithmetic device 430 detects feature points for each of the 2D images belonging to the initial 2D image set. The arithmetic device 430 matches feature points between images based on feature points of 2D images. Matched feature points represent correspondence points. The arithmetic device 430 obtains a fundamental matrix for 2D images using the correspondence points between images. The process of obtaining the fundamental matrix is the same as described above. The arithmetic device 430 may estimate a camera geometric structure using the fundamental matrix. The arithmetic device 430 may optimize the camera geometric structure using the BA technique. The arithmetic device 430 extracts the tie point(s) used in the BA technique.

The arithmetic device 430 determines an index set of images in which tie points used for geometric structure estimation are detected.

The arithmetic device 430 determines priorities based on each tie point to configure effective 2D images. The arithmetic device 430 calculates tie point score for each tie point. The arithmetic device 430 determines the priority based on an average value of tie point scores for each image. The arithmetic device 430 may remove a 2D image having the lowest priority or a plurality of lower priority 2D images from the 2D image set based on the priority. Through this process, the arithmetic device 430 may extract effective 2D images.

The arithmetic device 430 may perform 3D image reconstruction using the effective 2D images. The arithmetic device 430 may reconstruct a 3D image from the effective 2D images using one of various 3D image reconstruction techniques.

The arithmetic device 430 may be a device, such as a processor, an application processor (AP), or a chip in which a program is embedded, for processing data and performing certain arithmetic operations.

In addition, the above-described method of prioritizing 2D images or method of reconstructing a 3D as described above may be implemented as a program (or application) including an executable algorithm that can be executed in a computer. The program may be provided by being stored in a transitory or non-transitory computer readable medium.

A non-transitory readable medium is a medium that can store data semi-permanently and can be read by a device, rather than a medium that stores data for a short moment, such as a register, cache, or memory. Specifically, the above-described various applications or programs may be provided by being stored in a non-transitory readable medium, such as a compact disk (CD), a digital versatile disc (DVD), a hard disk, a Blu-ray disk, a Universal Serial Bus (USB), a memory card, a read-only memory (ROM), a programmable read only memory (PROM), an erasable PROM (EPROM), or an electrically erasable PROM (EEPROM), or a flash memory.

Transitory readable media refer to various RAMS, such as a Static RAM (SRAM), a Dynamic RAM (DRAM), a Synchronous DRAM (SDRAM), a Double Data Rate SDRAM (DDR SDRAM), an Enhanced SDRAM (Enhanced) a Synchronous DRAM (Synclink DRAM, SLDRAM), and a Direct Rambus RAM (DRRAM).

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A method of selecting a two dimension (2D) image for three dimension (3D) reconstruction, the method comprising:
receiving, by an image processing apparatus, 2D images captured at different positions or in different directions;
estimating, by the image processing apparatus, a geometric structure of a camera based on feature points detected from the 2D images, and optimizing the geometric structure of the camera using a bundle adjustment (BA) technique;
determining, by the image processing apparatus, a priority for each of the 2D images based on a number of tie points used in the BA process; and
selecting, by the image processing apparatus, final 2D images to be used for 3D reconstruction based on the priorities of the 2D images.

2. The method of claim 1, wherein the optimizing of the geometric structure of the camera includes:
detecting, by the image processing apparatus, feature points in each of the 2D images;
matching, by the image processing apparatus, the feature points between the 2D images based on the feature points;
obtaining, by the image processing apparatus, a fundamental matrix for images, of which the feature points are matched, among the 2D images;
estimating, by the image processing apparatus, the geometric structure of the camera using the fundamental matrix; and
optimizing, by the image processing apparatus, the geometric structure of the camera using the BA technique.

3. The method of claim 1, wherein the determining of the priority includes:
calculating, by the image processing apparatus, a score for each of the tie points used in the BA process based on a number of 2D images in which the tie point is present; and
determining, by the image processing apparatus, a priority for each of the 2D images based on the score for at least one tie point present in each of the 2D images.

4. An image processing apparatus for selecting a two dimension (2D) image for three dimension (3D) reconstruction, the image processing apparatus comprising:
an interface device configured to receive 2D images captured at different positions or in different directions; and
an arithmetic device configured to:
estimate a geometric structure of a camera based on feature points detected from the 2D images;
optimize the geometric structure of the camera using a bundle adjustment (BA) technique;
determine a priority for each of the 2D images based on a number of tie points used in the BA process; and
select final 2D images to be used for 3D reconstruction based on the priorities of the 2D images.

5. The image processing apparatus of claim 4, wherein the arithmetic device is configured to:
match feature points detected from each of the 2D images;
estimate the geometric structure of the camera using a fundamental matrix for images, of which the feature points are matched, among the 2D images, and
optimize the geometric structure of the camera using the BA technique.

6. The image processing apparatus of claim 4, wherein the arithmetic device is configured to:
calculate a score for each of the tie points used in the BA process based on a number of 2D images in which the tie point is present; and
determine a priority for each of the 2D images based on the score for at least one tie point present in each of the 2D images.

7. An image reconstruction apparatus for reconstructing a three dimension (3D) image, the apparatus comprising:
an interface device configured to receive 2D images captured at different positions or in different directions; and
an arithmetic device configured to:
estimate a geometric structure of a camera based on feature points detected from the 2D images;
optimize the geometric structure of the camera using a bundle adjustment (BA) technique;
determine a priority for each of the 2D images based on a number of tie points used in the BA process;
select effective 2D images among the 2D images based on the priorities; and
reconstruct a 3D image using the effective 2D images.

8. The image reconstruction apparatus of claim 7, wherein the arithmetic device is configured to:
match feature points detected from each of the 2D images;
estimate the geometric structure of the camera using a fundamental matrix for images, of which the feature points are matched, among the 2D images; and
optimize the geometric structure of the camera using the BA technique.

9. The image reconstruction apparatus of claim 7, wherein the arithmetic device is configured to:
calculate a score for each of the tie points used in the BA process based on a number of 2D images in which the tie point is present; and
determine a priority for each of the 2D images based on the score for at least one tie point present in each of the 2D images.
